(19) United States
(12) Patent Application Publication
(10) Pub. No.: US 2014/0361680 A1
(43) Pub. Date: Dec. 11, 2014

(54) LIGHTING SYSTEM USING DISPERSED FLUORESCENCE

(71) Applicant: Q TECHNOLOGY, INC., Livermore, CA (US)

(72) Inventor: Thomas E. Stack, Oxford, MI (US)

(73) Assignee: Q TECHNOLOGY, INC., Livermore, CA (US)

(21) Appl. No.: 14/301,308

(22) Filed: Jun. 10, 2014

Related U.S. Application Data
(60) Provisional application No. 61/833,415, filed on Jun. 10, 2013.

(51) Int. Cl. F21K 99/00; C09K 11/02; F21V 29/00

(52) U.S. Cl. CPC F21K 9/56; F21V 29/30; C09K 11/025
USPC 313/498; 252/301.36; 252/301.4 S; 252/301.4 F

(57) ABSTRACT

A system for generating light using a blue or ultraviolet light emitter as excitation source for dispersed fluorescent material is disclosed. A light transmissive dispersant, which may colloidally suspend or chemically dissolve a fluorescent material, acts to distribute the fluorescent material over a spatial region. The combination of primary and secondary light emission results in a broader light spectrum than the primary emitter alone would produce. Extending the light transmissive dispersant medium containing fluorescent material over a spatial region spanning beyond point sources will minimize or eliminate bright spots, which might otherwise result from point sources. Use of a liquid dispersant may result in convective cooling of the emission sources.

### REFERENCE TO RELATED APPLICATIONS

This patent application claims the benefit of priority under 35 USC sections 119 and 120 of a provisional patent application filed Jun. 10, 2013 having Application Ser. No. 61/833,415. The entirety of the said U.S. provisional application 61/833,415, entitled “Lighting System Using Dispersed Fluorescence”, is incorporated by reference herein.

### BACKGROUND OF THE INVENTION

The present invention relates generally to lighting systems and methods and more specifically to lighting sources using fluorescence.

### DESCRIPTION OF RELATED ART

Incandescent, gaseous discharge fluorescent, and LED lamps are commonly used to illuminate living and working spaces. At times users find that incandescent lamps consume excessive energy and radiate excessive heat. On the other hand gas discharge fluorescent lamps often use mercury and present disposal issues. Still yet, LEDs tend to be directional point sources and so require additional optics to produce uniform illumination. In summary, these technologies have complementary issues concerning energy consumption, toxic waste disposal, and illumination quality.

The use of lenses and minors to produce uniform LED output light distribution tends to require space. In general also, even though LEDs are more efficient light sources, they are also more heat sensitive and so heat removal presents a bigger issue with them.

An illumination source that overcomes the numerous problems associated with prior art would be valuable for many lighting applications.

### BRIEF SUMMARY OF THE INVENTION

The use of dispersed fluorescence as part of the present invention overcomes the problems associated with prior art. In a compact space not bigger than an incandescent bulb, a large light output is possible with even light distribution, thus reducing the disadvantages of other LED designs requiring large optics and heat sink.

The present invention is made of a blue or shorter wavelength (possibly ultraviolet) source and fluorescent material dispersed in a liquid or solid. Additional benefits are that under some choices of materials the light output is uniform enough to look at directly.

In a preferred embodiment, a liquid medium supporting the fluorescent material also allows for efficient LED heat removal. In effect, the liquid with dispersed fluorescence serves two purposes: first, to produce a uniform illumination pattern, and secondly to minimize external heat sink requirements. By serving both optical and thermal purposes, the improved design using dispersed fluorescence can perform in a more compact space than traditional LED prior art designs, which require separate optics and heat sink. Compactness is possible through not requiring sizable lens or mirror optics to modify the LED light, and not requiring a sizable metal heat sink.

Proper choice of materials allows the dispersed fluorescence light source to be energy efficient, long lasting, and environmentally friendly. Further, the dispersed fluorescence light source can be aesthetically pleasing in not presenting one or more small but intense points of light that are uncomfortable to look at, but instead present a diffuse light spread that is as comfortable to look at as traditional incandescent or fluorescent sources.

Other productive uses and advantages will be apparent from reading the following detailed description.

### BRIEF DESCRIPTION OF THE DRAWINGS

FIG. 1 is a perspective external view illustrating the overall layout of a lighting source according to the present invention;

FIG. 2a is a perspective view showing the presence of a dispersed solid in a liquid carrier, or solid carrier of separate chemical composition;

FIG. 2b is a perspective view of the light emitting behavior of a dispersed solid with fluorescent properties as in FIG. 2a but with an excitation of blue or shorter wavelength light; and

FIG. 3 shows the overall behavior of the lighting system with the active light re-emitting material.

### DETAILED DESCRIPTION

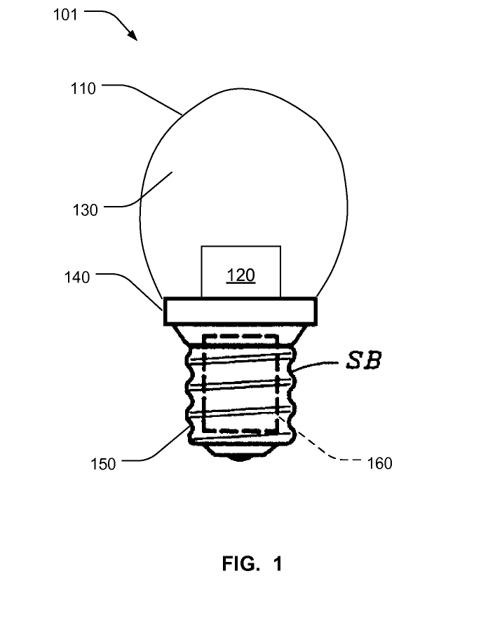

In FIG. 1, an embodiment of the present invention 101 consists of a light transmissive envelope 110 with excitation light source 120. A light re-emitting medium 130 exists between the excitation light source 120 and the envelope 110. A base 140 is shown to portray connection to electrical supply and mechanical support, and may be of type well known in the art. Optionally, circuitry to modify the electricity applied through the base 150 and sent to the source 120 may be at least partially enclosed within the socket as for example, the region shown in dashed box 160.

The excitation light source 120 may be a blue or shorter wavelength source as known to the art. The chemistry of the material may, for example, be InGaN (indium gallium nitride), or that used in a standard white LED known to the art.

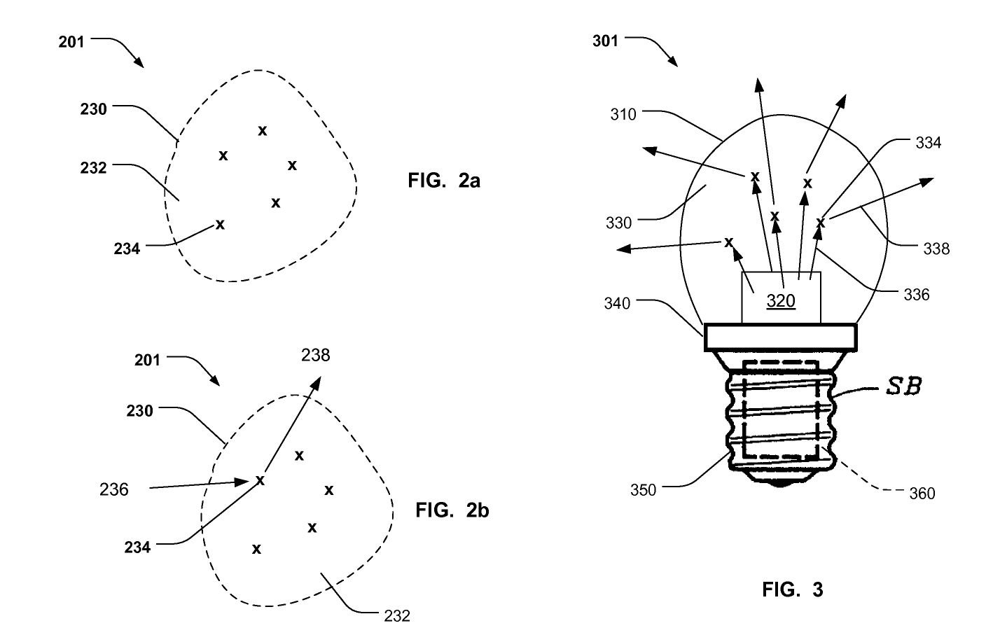

FIG. 2a shows detail of a light re-emitting medium 201, corresponding to medium 130 in FIG. 1. The medium 201 is composed of fluorescent material 234 suspended in the suspension medium 232. The fluorescent material 234 may be finely divided and dispersed within suspension medium 232 to form what is known in the art as a colloidal suspension. As typical of colloidal suspensions, particles of the fluorescent material 234 may be insoluble but will stay in suspension. It is believed this happens because the solid material is sufficiently finely divided for its buoyancy or weight to be negligible in response to random molecular collisions within the liquid. This may for example occur when the particle sizes in a colloidal suspension range from one to one thousand nanometers.

Though preferably dispersed within a liquid medium, it is also possible to contain the dispersed fluorescent material in a solid or gel suspension. In some embodiments, the suspension solid, liquid, or gel may be a polycarbonate or petroleum based product. If water is used, a secondary ingredient may be added to lower the freezing point temperature. If a solid, it may also be possible to use a polycarbonate material or Lexan as the dispersion medium or solid solvent.

Because particles within a suspension medium may be shown in a drawing, this variation is shown here within FIGS. 2a and 2b. However, for use with the invention, the more general idea is to have a dispersed fluorescent material whether suspended as a colloid or dissolved in a solution.

Therefore, in this context, “dispersed” is intended to mean either a finely divided solid suspended throughout a liquid, solid, or gel carrier, or alternatively a chemical dissolved within a liquid, solid, or gel solvent. The alternative, a light transmissive chemical solution of one or more fluorescent substances would appear uniform at all optical magnifications and so is not amenable to illustration. However, again either a colloid or chemical solution exhibiting fluorescent properties would be appropriate for use with this invention.

FIG. 2b shows the light re-emission by fluorescent particle 234 when struck with higher energy (blue or shorter wavelength) light as depicted by ray 236. Upon being struck, the particle re-emits light at lower energy as depicted by ray 238.

The fluorescent material may be a standard known light re-emitter. However one or more chemical species may be used, for example to separately produce red with CaAlSiN3:Eu; and green with copper and aluminum doped zinc sulfide.

The solvent or suspension material 232 may also be blended with a UV inhibitor such as an HALS (hindered amine light stabilizer) to help protect against degradation due to increased UV exposure.

A chemical could also be added to prevent clumping of the dispersed colloidal material.

In FIG. 3 an embodiment of the present invention is shown in use when energized with an external power source through standard bulb socket SB. Again, electronics to condition the input power could be disposed in a region such as that shown by dashed box 360.

Visible light or ultraviolet emission from the light excitation source 320 causes particles 334 suspended in the light re-emitting medium 330 to emit visible light at a longer wavelength. This is shown, for example where ray 336 meets particle 334 and is re-emitted with lower wavelength as ray 338.

In the figure, the rays are arranged so that they don't cross each other, to plainly show the light re-emission behavior. However, in practice, the light from source 320 would meet light emitting particles 332 at arbitrary angles and would in turn be re-emitted at still other arbitrary angles.

It is anticipated the light transmissive envelope 310 would be made of glass but it could also be made of plastic or quartz. Preferably the envelope would pass visible light but block UV.

The suspension 330 would preferably allow light transmission, have a minimal expansion coefficient, coexist well with the fluorescent material, and if a liquid at working temperature, not freeze within the storage temperature range.

### CONCLUSIONS, RAMIFICATIONS, AND SCOPE

Though the construction of the invention is planned to not require external heat sinks or light modifying optics, these also may be used within the context of the invention.

It is also possible to use a UV source, for example, of sufficient intensity so as to fluoresce a material coated on the interior of light transmissive envelope. It would also be possible to use a mixed approach where some of the light emission would be from fluorescence dispersed in the medium and some from a coating on the light transmissive envelope. Multiple excitation sources of different wavelengths may also be used.

In case of the possible expansion or contraction of fluid or gel material within the transparent envelope, a bladder, membrane, or diaphragm may be used so that the fluid or gel material presses inwardly or outwardly against the bladder, to contain displacements of the fluid or gel material along with said expansion or contraction.

With the bladder, membrane, or diaphragm, in case of material contraction, gaps or voids between the fluid or gel and light transmissive envelope would not form within the operating temperature and pressure range of the lighting system. Conversely, with the bladder, membrane, or diaphragm to relieve pressure, excess pressure would not build up upon fluid or gel expansion within the operating temperature and pressure range of the lighting system.

The spirit of the present invention provides a breadth of scope that includes all methods of making and using it. Any variation on the theme and methodology of accomplishing the same that are not described herein would be considered under the scope of the present invention.

What is claimed is:

1. A light source, comprising:
a light transmissive envelope;
an emission source producing blue or ultraviolet light, or a mixture thereof; and
a suspension of fluorescent material interspersed between the emission source and the light transmissive envelope.

2. A suspension of fluorescent material for use with a light source, comprising:
a solid or liquid capable of transmitting both ultraviolet and visible light;
and a dissolved fluorescent substance.

3. A suspension of fluorescent material for use with a light source, comprising:
a solid or liquid capable of transmitting both ultraviolet and visible light; and
a colloidally suspended fluorescent substance.
